(19) United States
(12) Patent Application Publication
(10) Pub. No.: US 2010/0002953 A1
(43) Pub. Date: Jan. 7, 2010

(54) DETECTION AND REDUCTION OF RINGING ARTIFACTS BASED ON BLOCK-GRID POSITION AND OBJECT EDGE LOCATION

(75) Inventors: Ihor O. Kirenko, Eindhoven (NL); Aliaksei V. Sedzin, Eindhoven (NL)

Correspondence Address: MCKEE, VOORHEES & SEASE, P.L.C., 801 GRAND AVENUE, SUITE 3200, DES MOINES, IA, 50309-2721, US

(73) Assignee: PACE PLC, West Yorkshire (GB)

(21) Appl. No.: 12/440,042

(22) PCT Filed: Sep. 17, 2007
(86) PCT No.: PCT/IB2007/053735

§ 371 Date: Apr. 21, 2009

(30) Foreign Application Priority Data
Sep. 20, 2006 (EP) EP 06120973.0

(51) Int. Cl. G06K 9/40

(52) U.S. Cl. 382/268

(57) ABSTRACT

The invention proposes a method (FIG. 2) and respective devices (FIG. 2) and software for an algorithm to detect and remove ringing artefacts and mosquito noise in decompressed pictures and video. The proposed idea is based on the observation that ringing is spatially localized within a block, which contains at least a part of an object edge, in particular a strong object edge. Blocks affected by ringing are detected by analyzing (1) a block grid position, location (2) of an object edge and by comparing (7) local spatial activities (Act af, Act nor) of adjacent blocks, i.e. affected blocks and nor) not-affected blocks.

### FIELD OF THE INVENTION

The invention relates to a method of processing data, which represent at least one picture potentially affected by artefacts due to transform coding.

The invention also relates to a coding device being adapted for executing the steps of the method and a respective data signal and respective implementations thereof. The invention leads to an encoder device, a decoder device, a display device and a respective apparatus.

The invention also relates to a computer program product and a storage medium readable by a computing device.

### BACKGROUND OF THE INVENTION

Coding a picture or a sequence of pictures comprises different steps. Each picture is composed of a bidimensional array of picture elements or pixels, each of them having luminance and chrominance components. For encoding purposes, the picture is subdivided into non-overlapping blocks of pixels. A so-called discrete cosine transform (DCT) can be applied to each block of the picture. The coefficients obtained from this DCT are rounded to the closest value given by a fixed quantization law and then quantized, depending on the spatial frequency within the block that they represent. The quantized data thus obtained can then be coded. During a decoding step, usually, the coded data are successively decoded, treated by inverse quantization and inverse discrete cosine transform, and are finally filtered before being displayed.

Quantization is, in data transmission, one of the steps for data compression and is a treatment which involves losses. The quantization errors introduced by quantization of the DCT coefficients in the coding have as a main result the occurrence of the Gibb's phenomenon artefacts and noise caused by truncation of the high-frequency coefficients through quantization during encoding. These kind of artefacts and noise occur near high-frequency areas which are located in low activity regions and may appear as “false edges” in the picture.

Modern image and video compression schemes such as JPEG or MPEG use block-based processing. Each block of pixels is, according to contemporary methods, DCT transformed and quantized separately, which leads to the above-mentioned Gibb's phenomenon artefacts and noise. Independent quantization of adjacent blocks might create a block edge between those blocks. The visibility of such block edges depends on the quantization step and flatness of the corresponding image area. Additionally to “blocking artefacts”, independent block-based quantization causes other types of coding artefact: ringing and mosquito noise.

The ringing resembles rippling of an edge as a kind of ghost effect. It is more pronounced along sharp edges in low energy sections of an image. As outlined above it is caused by a coarse quantification of the AC coefficients, which are frequency coefficients as opposed to the continuous coefficient (DC), of the DCT.

The mosquito noise effect manifests itself as a fluctuation of luminance/chrominance levels in a block on the boundary of moving objects and the background area. The intensity of fluctuations is usually not huge; however, since the human visual system is highly perceptual to such kind of changes, this flickering becomes quite irritating. It is introduced by inter-frame (or inter-picture) coding: from frame to frame, the prediction error is coded with differing coarseness of quantification.

In general the visibility of these artefacts mainly depends on the parameters of spatial activity around an object edge, in particular a strong object edge, in the original, i.e. the uncompressed image, a value of a quantization step and a strength of object edges. The stronger is the edge and flatter is the surrounding background, the more visible ringing will be after compression.

Numerous approaches are known in the art to reduce ringing artefacts and/or mosquito noise but mostly exploit only single selected properties of ringing or mosquito noise, a specific one thereof is their occurrence around strong object edges as outlined above.

In US 2004/0184669 A1 a method is disclosed for removing ringing artefacts from locations near dominant edges of an image reconstructed after compression. In U.S. Pat. No. 6,668,097 B1 a method and apparatus for the reduction of artefact in decompressed images using morphological post-filtering is disclosed.

There are still some significant drawbacks of the prior art methods as the latter inter alia detect a location and, possibly, a direction of a strong object edge and subsequently simply apply a low-pass filter orthogonal to the detected object edge direction as proposed by Park et al. in IEEE Transactions on CSVT, vol. 9, no. 1, February 1999, pp 161-171. The disclosed method comprises, for a given picture, a first step of edge detection followed by a low-pass filtering. So this prior art approach assumes that the ringing is always present around strong edges and the size of a ringing area is assumed to be constant along the edge. Apertures of de-ringing low-pass filtering usually are not dependent of the actual ringing area. These measures, of course, totally neglect the specific and individual demands of each single picture while in such simple approaches the low-pass filtering may introduce blurring effects in areas of the picture where extreme values of luminance can be found. This may lead to a blurring of texture around objects, which will be visible as a so-called “halo effect”. Furthermore strong filtering orthogonally to a detected object edge might cause aliasing artefacts such as staircases if the direction of the edge is different from simply horizontal or vertical. Usually there is no protection against blurring of texture around an object edge.

US 2006/0050783 A1 discloses a mosquito noise reduction. The method comprises segmenting a picture into multiple regions such as edge, near edge, flat, near flat and texture regions. Temporal filtering configurations for reducing temporally varying coding artefacts are suggested. U.S. Pat. No. 6,920,252 B2 discloses a spatial activity detection. A gradient filtering is used to determine edges. A determination of ringing artefacts is based on the spatial characteristics. The mentioned problems are addressed only imperfect by these methods.

Ringing is detected as a region with relatively high spatial luminance activity located between a strong object edge, which is detected in previous steps of the algorithms, and flat image area, which is referred to as a so-called Near Edge and Flat (NEF) Region. The main disadvantage of the approach described in the above two documents results from the difficulty to determine a potential size of the NEF region as well as size of neighboring flat area before actually calculating activities of those regions. US 2006/0050783 proposes 3D image segmentation to detect regions with different spatial activity. Segmentation of the regions based on the different spatial activities makes algorithms computationally expensive and not robust to the possible processing of the image after decoding. Also in U.S. Pat. No. 6,920,252 it is proposed to use a fixed threshold to differentiate flat and active regions. However, disadvantageously in the case a decoded image was up-scaled after decoding, the spatially active regions would be blurred and could be not detected as NEF regions during segmentation. Besides, the above documents do not give guidance how to define a maximum size of the NEF to be regarded as ringing region and not texture located between object edge and flat area.

In U.S. Pat. No. 6,999,630 B1 a method as described in the introduction is disclosed to circumvent the latter problems. For the first time individual areas in the picture where a ringing artefacts is likely to occur are predicted. The method comprises the steps of:

detecting edge pixels within a picture,

determining pixels to be filtered from among pixels which were not detected as edges in the previous step,

replacing at least a pixel to be filtered with a pixel belonging to a close neighborhood of said pixel, said close neighborhood comprising said pixel and pixels adjacent to said pixel.

In this approach it has been recognized that areas along edges may be filtered without disturbing the picture edges. The pixels belonging to these areas may be corrected by being replaced by an adjacent pixel. Thereby annoying blurring effects, as usually caused by a low-pass filter of the prior art, are avoided.

Although the latter approach already provides fairly good results it is nevertheless desirable to apply a low-pass filter in many cases as picture quality can still be improved. Nonetheless, still blurring effects should be carefully avoided. The problems and limitations of prior art approaches should be overcome and it is desirable to aim at an improved detection and suppression of ringing artefacts without blurring of fine picture details, though using a low-pass filter.

### SUMMARY OF THE INVENTION

This is where the invention comes in, the major object of which is to remove or at least diminish some block-based video compression artefacts. In particular it is desirable to diminish ringing and/or shimmering, also known as mosquito noise.

Accordingly it is an object of the invention to provide method of processing data, a respective coding device and implementations thereof, a respective data signal of data and a respective computer program product and a storage medium, capable of at least diminishing some block-based video compression artefacts in an improved way.

With regard to the method the object is achieved by a method of processing data representing at least one picture potentially affected by artefacts due to imperfect transform coding, the method comprising the steps of:

determining a grid of pixel blocks on a picture;

determining presence of an object edge on the picture;

determining at least one affected pixel block containing a pixel of the object edge;

determining at least one not-affected pixel block neighboring the affected pixel block, the not-affected pixel block not containing a pixel of the object edge;

evaluating a first spatial activity of the affected pixel block;

evaluating a second spatial activity of the non-affected pixel block;

comparing the first spatial activity and the second spatial activity.

The at least one picture in particular can be a single still picture or also a sequence of pictures.

The data are preferably part of a data stream representing the picture or sequence of pictures, in particular of a low-bitrate video signal. Particularly the pictures are previously encoded and decoded, in particular previously compressed and decompressed. Such processing may cause transform artefacts. So the method is particularly adapted as an artefact reduction post-processing data.

A contemporary transform coding is known as the DCT transform (Discrete Cosine Transform). However, the invention shall also embrace other forms of a transform, in particular future transforms like e.g. wavelets.

Particularly, artefacts are meant to comprise the Gibb's phenomenon artefacts and noise like e.g. ringing and mosquito noise. The proposed method is particularly advantageous upon diminishing or remove these kind of artefacts and noise, generally referred to as transform imperfections.

Generally speaking a spatial activity is meant to be a measure for the pattern energy of pixels, like flatness or texture of pixels, e.g. in form of a variance of pixels of a predetermined area e.g. of a pixel block.

According to the invention an affected pixel block is defined as a pixel block which contains at least one pixel of an object edge. A not-affected pixel block is defined as pixel block which does not contain a pixel of an object edge and which is neighboring the affected pixel block.

The not-affected pixel block is at least neighboring the affected pixel block. It is particular preferred that the not-affected pixel block is adjacent to the affected pixel block.

In its basic idea the present invention is directed to the observation that ringing is spatially localized within blocks, which contain an object edge or a part thereof. Consequently such blocks containing an object edge pixel are defined as affected pixel blocks above. In particular this is true for a strong object edge. The invention has recognized clearly that if a e.g. DCT block includes at least one pixel from an object edge, then ringing may impact all pixels within this block, but at the same time, adjacent and/or neighboring blocks, which do not contain an object edge, i.e. the mentioned object edge or another object edge, will be free from ringing. In other words, blocks being free of pixels of an object edge will be basically free from ringing and won't cause ringing in neighboring or adjacent blocks. Consequently such blocks not containing an object edge pixel are defined as not-affected pixel blocks above. This new insight is supplemented by the perception, that the artefact becomes visible only if a spatial activity of a ringing area, i.e. one or more blocks, is higher than the activity of background. If the background contains a texture, then ringing is masked by spatial high frequencies of that texture. This new insight leads to an advantageous innovative concept for the detection of regions of a picture which are potentially affected by artefacts due to imperfect transform coding.

The invention has been able to exploit this insight by providing the claimed method of analyzing data. The invention found that it is possible to detect potentially affected blocks by determining and analyzing a block grid position and a location of an edge, in particular of a comparingly strong edge. It is possible to determine whether ringing is actually present within those detected blocks by comparing spatial activities within potentially affected blocks, referred to as affected blocks when they contain a pixel of an object edge, and within neighboring or adjacent potentially ringing-free blocks, referred to as not-affected blocks when they do not contain a pixel of an object edge. The ringing can be surpassed by filtering, in the case the ringing is present. Preferably a low-pass filtering with the threshold dependent on the magnitude of the object edge and the difference between activities of affected block and neighboring not-affected blocks is applied. In the case the ringing is considered to be not effective filtering is not applied. So the invention also leads to a particular preferred method of processing data additionally comprising the step of applying a filter to the affected pixel block in dependence of the outcome of the comparing step.

Contrary to prior art, the proposed concept of the instant invention avoids a necessity to segment the image into regions of different spatial activity, because the compressed image is already segmented by blockiness. The main idea of the invention makes use of the fact that ringing is localized within a e.g. DCT block, which comprises an object edge. The steps of the method are executed using the borders of block given by the block grid. Complex measures of defining a ringing area are advantageously avoided. Thus, advantageously, the size of the potential ringing region is known exactly, before calculation of spatial activities. The proposed ringing region detection is robust to image scaling, as long as a block grid is detected. Thus extensive spatial activity calculation, be it 2D or 3D, can be avoided by the proposed invention. The concept uses a block grid position for defining ringing regions and for distinguishing between flat blocks and ringing blocks and superior results are achieved.

As compared to commonplace measures a variety of further advantages are achieved by the concept of the instant invention.

The inventive concept allows to exploit the nature and properties of ringing by its ringing detection mechanism. De-ringing, i.e. blurring, is executed only in cases when the ringing is visible, i.e. in the case the comparison step indicates a difference in spatial activities between affected and not-affected neighboring blocks and when the ringing is not masked by a background texture. Here it is also possible to detect and/or measure a likelihood or severity of an artefact. Consequently de-ringing can be applied in dependence of the severity. De-ringing is applied only to pixels, which are affected by ringing. The aperture of de-ringing filter can be adapted exactly congruent to the area of ringing, i.e. no less, no more. Generally a filter Kernel size and shape can be matched to the actual ringing pattern. An algorithm of the proposed inventive concept can be implemented rather independent of external, e.g. coding parameters and a fine-tuned control. This is due to the fact that all decisions are taken based on a local, i.e. block based, activity analysis. In preferred configurations the same values of thresholds might be used for sequences with a broad range of video quality. The proposed concept has shown up to be particular effective for detection and removing ringing around even very small objects, with the size smaller than a block size.

With regard to the coding device the object is achieved by a coding device, in particular being adapted for executing the steps of the above outlined inventive method, comprising:

a grid determining module for determining a grid of pixel blocks on a picture;

an edge searching module for determining a presence of an object edge on the picture;

a block identifying module for determining at least one affected pixel block containing a pixel of the object edge; and

a block identifying module for determining at least one not-affected pixel block neighboring the affected pixel block, the not-affected pixel block not containing a pixel of an object edge;

a evaluation module for evaluating a first spatial activity of the affected pixel block; and

a evaluation module for evaluating a second spatial activity of the non-affected pixel block;

a comparison module for comparison of the first spatial activity and the second spatial activity.

The invention also leads to a respective encoder device, a respective decoder device each comprising the coding device according to the concept of the instant invention. Such coding devices use the above outlined innovative method of analyzing data in an advantageous way. The devices and developed configurations thereof as outlined above may be implemented by digital circuits of any preferred kind, whereby the advantages associated with digital circuits may be obtained. A single processor or other unit may fulfill the functions of several means or modules recited in the claims. A digital circuit or processor of the mentioned kind may be implemented in one or more multi-processor system.

The invention is particular preferred for providing the coding device in form of a filter device. Advantageously such coding device further comprises:

a control module for applying a filter to the affected pixel block in dependence of the output of the comparison module

the filter.

The invention also leads to a respective display device comprising the filtering device of and/or the encoder device and/or the decoder device according to the concept of the instant invention. The display device is in particular selected from the group consisting of: Liquid Crystal Display (LCD), Plasma Display Panel (PDP) and the like, in particular a HD display.

The invention also leads to a respective apparatus comprising a display device according to the concept of the instant invention, in particular an apparatus selected from the group consisting of TV, Video Camera, Mobile Phone. Such a display device and apparatus use the above outlined innovative method of processing data in an advantageous way.

As regards the data signal the object is achieved by a data signal of data, in particular being processed by the inventive method, which data represent at least one picture potentially affected by artefacts due to imperfect transform coding said picture having

a grid of pixel blocks, in particular determined on a picture;

an object edge being present on the picture; and

at least one affected pixel block containing a pixel of the object edge; and

at least one not-affected pixel block neighboring the affected pixel block not containing a pixel of an object edge;

wherein

the data signal is assigned to an affected pixel block wherein the affected pixel block has a first spatial activity and the not-affected pixel block has a second spatial activity.

In a particular preferred development of the invention the data signal is filtered in dependence of the outcome of a comparison of a first spatial activity evaluated for the affected pixel block and a second spatial activity evaluated for the not-affected pixel block.

It is to be understood that the above outlined inventive method is suitable for generating the above-mentioned data signal, in particular using respective circuitory and the like. The data signal is preferably transmitted on a signal carrier like a conductor, a circuit path, a signal line or a carrier wave.

According to the concept of the instant invention it is advantageously possible to assign the data signal to a specific address of a block in a block grid, e.g. an address of an affected block.

The invention also leads to a respective computer program product and a respective storage medium. In particular a download computer program product and the like is advantageous to be used as a standalone computer program product for updating a device as mentioned above.

Developed configurations of the invention are further outlined in the dependent claims.

A preferred development of the invention is particular advantageous for diminishing and/or removing ringing artefacts and/or mosquito noise.

Preferably the method steps are performed by operating on a luminance signal and/or a chrominance signal comprising the data. Preferably the data are part of a data stream of a video signal, preferably a low-bitrate video signal. However, the method may also be applied advantageously to other forms of signals, such as e.g. multi-media signals and the like.

Preferably the pixel block, in particular an affected pixel block and/or a not-affected pixel block, is assigned to a block grid position. The grid consists of a number of pixel blocks, advantageously each of 8×8 pixel size consisting of a 8-row by 8-column matrix, which has shown up to be a suitable size. The pixel blocks of the grid each have a known block grid position. Basically the grid may be determined for the actual picture. However, optionally or additionally, the grid of pixel blocks can also be determined from an encoded form, in particular compressed form, of the data if available during artefact reduction post-processing.

For determining the at least one affected pixel block an object edge is detected in the picture. Thus the affected pixel block is determined as potentially affected by ringing. Accordingly at least one not-affected pixel block is detected in the picture, which is neighboring, preferably adjacent to, the affected pixel block. Such a pixel block can be assumed as potentially not affected by ringing.

For this purpose in general any form of object edge location may be applied. It is also to be understood that the method, depending on the specific demands, may focus on a selected strength or kind of object edges, in particular comparably strong object edges. Advantageously a strong object edge is determined using a predetermined edge-threshold, which can be chosen depending on the specific demands.

Advantageously an object edge can be determined by generating a bit-map indicating at least one position of a pixel of the object edge. Thereby a detection of object edges can be implemented easily for a whole picture at once.

Also, advantageously the object edge can be determined by searching for at least one local maximum gradient between a pair of pixels. This is preferably implemented as a localized search in a luminance and/or chrominance signal.

Other forms of a detection method for relevant object edges, though less suitable as compared to those mentioned above, may be also chosen from US 2004/0184669 A1 and U.S. Pat. No. 6,668,097 B1 as mentioned in the introduction.

In general evaluating the spatial activity can be performed by any suitable method for estimating a spatial flatness or texture in a block. The following developed configurations of evaluating a spatial activity are not meant to be restrictive. Other forms of evaluation can be used as well in dependence of and adapted to the specific demands of the application.

Preferably a first spatial activity, i.e. the spatial activity of the affected block, is evaluated by calculating a mean value from all pairs of pixel gradients between the borders of the affected pixel block, in particular from all pairs of pixel gradients between the borders of the affected pixel block and the object edge. The latter configuration advantageously excludes strong object edges or an influence thereof from calculation of the activity of a block.

Preferably a second spatial activity, i.e. the spatial activity of the non-affected block, is evaluated by calculating a mean value from all pairs of pixel gradients between the borders of the not-affected pixel block, in particular from all pairs of pixel gradients which additionally each have a gradient below a predetermined edge-threshold. The latter configuration advantageously excludes strong object edges or an influence thereof from calculation of the activity of a block.

Preferably the first spatial activity and the second spatial activity are compared using a value of the second spatial activity multiplied by a factor instead of using the second spatial activity itself. According to a preferred configuration, the smaller the factor is, the more sensible is the inventive method for appliance of the filter of the inventive concept. In general the factor should be equal to or greater than one—an advantageous factor is two. The factor allows to introduce an advantageous measure between the first and second spatial activity and can be adapted according to the demands of the specific application.

Preferably the low-pass filter is not applied to the affected pixel block in the case the first spatial activity is almost equal to or below the second spatial activity. This indicates that the spatial activity in the affected block and the not-affected block are somewhat in the same range. In this case the preferred configuration of the inventive concept proposes that ringing or mosquito noise is not present or masked in the affected block—appliance of the filter is suppressed.

In turn, preferably, the low-pass filter is applied to the affected pixel block in the case the first spatial activity is above the second spatial activity. This indicates that the spatial activity in the affected block exceeds the spatial activity in the not-affected block, depending on the above-mentioned factor, significantly. In this case the preferred configuration of the inventive concept proposes that ringing or mosquito noise is present and not masked in the affected block to such an amount that appliance of the filter is maintained.

Advantageously the filter is a low-pass filter, in particular a low-pass 2D-filter, using a filter-threshold. In general the proposed concept of the invention allows to advantageously adapt filter parameters, like a threshold, aperture, Kernel and the like to the severity and the size of the artefact.

In a preferred embodiment the filter-threshold can advantageously be adapted to the severity of the artefact by determining a filter-threshold in dependence on the magnitude of the object edge and the first spatial activity and the second spatial activity. Particular suitable is to use the difference between the first spatial activity and the second spatial activity as a parameter for the severity of the artefact.

Advantageously the filter aperture contains all pixels between the borders of the affected pixel block and the object edge and pixels located next to a block border in adjacent blocks.

Further preferred configurations suggest advantageous forms of a filter. Advantageously the filter is a median filter.

In another preferred configuration the filter is a 2D-bilateral, in particular averaging, filter. A prominent and particular useful bilateral filter is described in further detail e.g. by C. Tomasi, R. Manduchi, in the article “Bilateral Filtering for Gray and Color Images”, published in Proceedings of the 1998 IEEE Intern. Conf. on Computer Vision, Bombay, India, which is incorporated by reference herein.

In a further preferred configuration advantageously the filter is a sigma filter with a filter-threshold. The filter-threshold is advantageously selected such that the first activity is below the filter-threshold and the filter-threshold is below half of a local maximum of pixels.

These and other aspects of the invention will be apparent from and elucidated with reference to the embodiments described in the detailed description hereinafter.

It is, of course, not possible to describe every conceivable configuration of the components or methodologies for purposes of describing the present invention, but one of ordinary skill in the art will recognize that many further combinations and permutations of the present invention are possible. In particular, as regards the method, the prescribed embodiments are not mandatory. A person skilled in the art may change the order of steps or perform steps concurrently using threading models, multi-processor systems or multiple processes without departing from the concept as intended by the current invention. The invention can be implemented by means of hardware comprising several distinct elements like e.g. a device, and by means of a suitably programmed computer. In particular in device claims enumerating several means, units or modules, several of these means, units or modules can be embodied by one and the same item of computer readable software or hardware. Accordingly the detailed description is meant to illustrate preferred embodiments of the inventive method as well as also preferred embodiments of a respective device and the like.

Whereas the invention has particular utility for, and will be described as associated with low-bitrate video signals comprising a sequence of pictures with a DCT block grid, it should be understood that the inventive method is also operable with other forms of data having artefacts like for example multi-media data and the like.

### BRIEF DESCRIPTION OF THE DRAWINGS

For a more complete understanding of the invention, reference should be made to the accompanying drawing, wherein:

FIG. 1 is an enlarged view of an examplifying picture having ringing artefacts around a strong object edge;

FIG. 2 is a viewgraph showing a flow-block-scheme of a preferred embodiment of an algorithm for the method according to the inventive concept;

FIG. 3 is scheme showing graphically an 8×8 DCT-block with pixels affected by ringing (light pixels) and an object edge (dark pixels).

### DESCRIPTION OF THE PREFERRED EMBODIMENTS

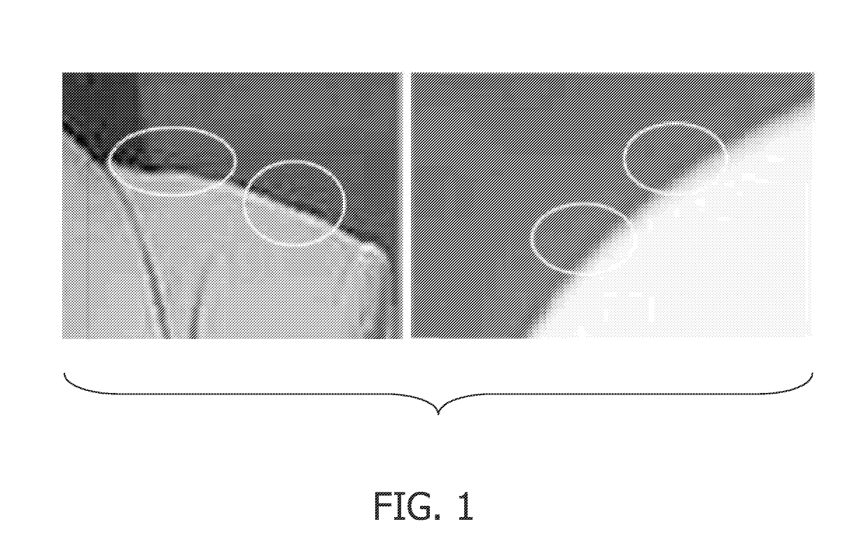

In FIG. 1 the exemplifying picture demonstrates the inventive perception that ringing artefacts predominantly occur around strong object edges. The light ovals indicate some of the blocks affected by ringing.

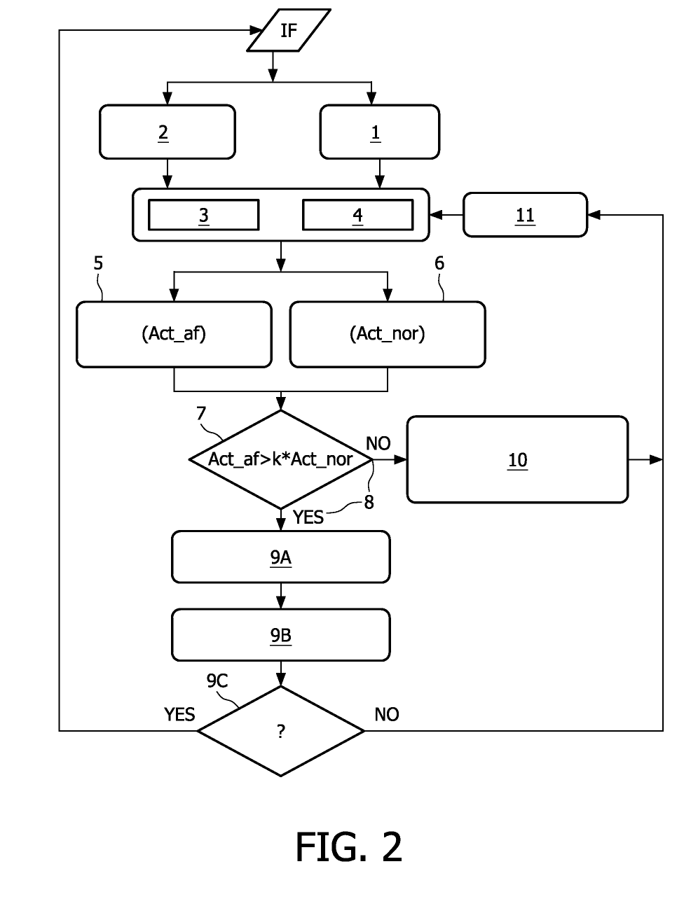

FIG. 2 shows a flow-block-scheme of a preferred embodiment of an algorithm for the method according to the inventive concept. The same FIG. 2 may also serve as sufficient disclosure for a respective filter device, which basically functions according to the illustrated method, and a respective data signal, which is basically a result of the illustrated method. The algorithm of this embodiment comprises the following main steps after providing a picture e.g. an input frame IF:

1. Determining a grid of pixel blocks on a picture. The algorithm can exploit the grid position information from the actual bit-stream of the input frame IF, or in modified embodiments, additionally or alternatively, from the compressed bit-stream, if such is available during the artefact reduction post-processing.

2. Detecting of an object edge. This can be implemented either for the whole picture, image or frame at once, with the generation of a bit-map indicating positions of edges or by searching for local maximum gradients between pairs of pixels in luminance and/or chrominance. In particular this step can be adapted to locate particular strong object edges, e.g. by adapting an edge threshold Thr_edge.

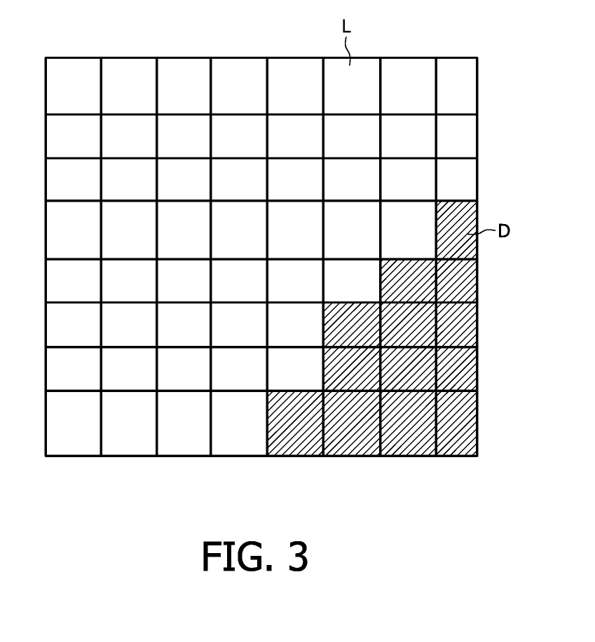

3. Determining at least one affected pixel block containing a pixel D of the object edge. Following up the results of steps 1 and 2 this step implies the detection of pixel blocks, which contain, as shown for example in FIG. 3, at least one pixel D of a detected object edge, and thus are “potentially affected” by ringing.

4. Determining at least one not-affected pixel block neighboring the affected pixel block, the not-affected pixel block not containing a pixel of an object edge. Following up the results of steps 1, 2 and 3 this step implies the detection of pixel blocks, which are blocks adjacent or at least neighboring to “potentially affected” block, but which do not contain an object edge pixel D. In other words, although not shown, but as may be derived from FIG. 3, the not-affected block is free of pixels D belonging to an object edge and only comprises pixels such like the “light” pixels L of FIG. 3, which do not belong to an object edge.

5. Evaluating a first spatial activity Act_af of the affected pixel block. In this embodiment the step is performed by analysis of a spatial luminance activity within blocks detected in step 3, i.e. the activity (Act_af) of an affected block. In this embodiment a value for the Act_af activity can preferably be calculated with

$$Act\_af = \frac{{\sum }_{i = 0}^{N} \vert {x}_{i} - {x}_{i + 1} \vert}{N} ,$$

where N is a number of all pairs of pixels within a block located between block edges and an object edge. In other words, as shown in FIG. 3, only the “light” pixels L will participate in calculation of activity Act_af, whilst those “dark” pixels D of the object edge are excluded.

6. Evaluating a second spatial activity Act_nor of the not-affected pixel block. In this embodiment the step is performed by analysis of a spatial luminance activity within blocks detected in step 4, i.e. the activity (Act_nor) of the not-affected blocks. A preferred value for the Act_nor activity can be calculated with

$$Act\_nor = \frac{{\sum }_{i = 0}^{N} \vert {x}_{i} - {x}_{i + 1} \vert}{M} ,$$

where M is a total number of pixel pairs in the block with gradients below an edge-threshold Thr_edge. The value of the edge-threshold Thr_edge can be chosen to be the same as was used in step 2 for detection of strong edges. Typically, the edge-threshold can be chosen as

Thr_edge>30.

In other words, strong edges are excluded from calculation of activity in the blocks.

The proposed calculation of local activities in steps 5 and 6 have shown up to be particular advantageous in this embodiment, however, a modified embodiment may use other calculations or methods for estimation of spatial flatness.

7. Comparing the first spatial activity Act_af and the second spatial activity Act_nor. In this step spatial activities in potentially affected and neighboring and/or adjacent not-affected blocks are compared. Here only the adjacent not-affected blocks are considered. In this specific embodiment the condition has been chosen to read

Act_af>k*Act_nor.

Normally, the parameter reads

k=2.

8. Applying a filter to the affected pixel block in dependence of the outcome of the comparing step 7.

In the case the condition is fulfilled it is assumed, that the affected block contains noisy area localized within the edges of the block, in other words this block contains ringing. In this case a filter is applied according to steps 9A and 9B.

If the activity in the potentially affected block is almost equal to or lower than the activity in the neighboring block(s), then it is assumed that there is a background image texture, or the area near the object edge is flat. In this case filtering to this block is not applied according to step 10.

9A, 9B. Applying a filter. Blurring of pixels L within the “area of ringing” as shown FIG. 3 is performed in the affected blocks. In one embodiment of the invention, filtering is implemented using a 2D bilateral, in particular averaging, filter 9B. Here the filter aperture includes all pixels of affected blocks except pixels of an object edge, i.e. only light pixels L in FIG. 3 and includes pixels located next to the block edges in adjacent blocks, i.e. pixels located at the left and top of block in FIG. 3. A threshold Th for the filter is selected in 9A. In another embodiment, the blurring is achieved using sigma filtering with a threshold (sigma) Th, as selected in 9A, which satisfies the condition: Act_af<Th<½ (local MAX), wherein “local MAX” can be a local maximum pixel or pixel gradient value. In yet another embodiment, sigma or bilateral filtering is replaced by a median filtering with the same aperture.

9C. An “end-of-frame” condition 9C is checked. In the case of “no-end-of-frame” the next blocks are analyzed as shown in step 11. In the case of “end-of-frame” the next input frame IF is analyzed.

10. Not-Applying a filter. The filter of step 9A, 9B is suppressed and the next blocks are analyzed as shown in step 11.

11. The next blocks are analyzed by performing steps 3 and 4.

In summary, the invention proposes a method and respective devices as shown for example in FIG. 2 and software for an algorithm to detect and remove ringing artefacts and mosquito noise in one or more decompressed pictures and video. The proposed idea is based on the observation that ringing is spatially localized within a block, which contains at least a part of an object edge, in particular a strong object edge D. Blocks affected by ringing are detected by analyzing 1 a block grid position, location 2 of strong object edges and by comparing 7 local spatial activities Act_af, Act_nor of neighboring and/or adjacent blocks.

While the invention has been described in detail, the foregoing description is in all aspects illustrative and not restrictive. It is understood that numerous other modifications and variations can be devised without departing from the scope of the invention.

The features disclosed in the foregoing description, in the claims and/or in the accompanying drawings may, both separately and in any combination thereof, be material for realizing further developed configurations of the invention in diverse forms thereof. The mere fact that certain measures are recited in mutually different dependent claims does not indicate that a combination of these measures cannot be used to advantage.

Accordingly, the present invention is intended to embrace all such alterations, modifications and variations that fall within the spirit and scope of the appended claims. In particular any reference signs placed between parentheses in the claims shall not be construed as limiting the scope of the invention. The wording “comprising” does not exclude other elements or steps. The wording “a” or “an” does not exclude the presence of a plurality of a respective feature.

### REFERENCE NUMERALS

1 determining grid
2 detecting object edge
3 determining affected pixel block
4 determining not-affected pixel block
5 evaluating first activity
6 evaluating second activity
7 comparing activities
8 outcome
9A, 9B applying filter
9C end of frame condition
10 not-applying filter
11 next block
L “light” pixel not belonging to edge
D “dark” pixel belonging to edge

1-37. (canceled)

38. A method of analyzing data, which represent at least one picture potentially affected by artifacts due to imperfect transform coding, the method comprising the steps of:
determining (1) a grid of pixel blocks on the picture;
determining (2) a presence of an object edge on the picture;
determining (3) at least one affected pixel block containing a pixel of the object edge;
determining (4) at least one not-affected pixel block neighboring the affected pixel block, the not-affected pixel block not containing a pixel of an object edge;
evaluating (5) a first spatial activity (Act af) of the affected pixel block;
evaluating (6) a second spatial activity (Act nor) of the not-affected pixel block;
comparing (7) the first spatial activity (Act af) and the second spatial activity (Act nor).

39. A method as claimed in claim 38 further comprising the step of: applying (9A, 9B) a filter to the affected pixel block in dependence of the outcome (8) of the comparing step (7).

40. A method as claimed in claim 38 characterized by operating on a luminance signal and/or a chrominance signal comprising the data.

41. A method as claimed in claim 38 characterized in that a pixel block is assigned to a block grid position.

42. A method as claimed in claim 41 characterized in that the grid of pixel blocks is determined from an encoded form of the data.

43. A method as claimed in claim 38 characterized in that an object edge is determined (2) by generating a bit-map indicating at least one position of a pixel of the object edge.

44. A method as claimed in claim 38 characterized in that the first spatial activity (Act af) is evaluated (5) by calculating a mean value from all pairs of pixel gradients between the borders of the affected pixel block.

45. A method as claimed in claim 38 characterized in that the second spatial activity (Act nor) is evaluated (6) by calculating a mean value from all pairs of pixel gradients between the borders of the non-affected pixel block.

46. A method as claimed in claim 38 characterized in that the first spatial activity (Act af) and second spatial activity (Act nor) are compared (7) using a value of the second activity multiplied by a factor (k) instead of using the second activity itself.

47. A method as claimed in claim 38 characterized by not applying (10) a filter to the affected pixel block in the case the first activity is almost equal to or below the second activity.

48. A method as claimed in claim 38 characterized by applying (9A, 9B, 9C) a filter to the affected pixel block in the case the first activity is above the second activity.

49. A method as claimed in claim 38 characterized by determining a filter-threshold (Th) in dependence on the magnitude of the object edge and the first spatial activity (Act af) and the second spatial activity (Act_nor).

50. A method as claimed in claim 38 characterized in that a filter aperture contains all pixels (L) between the borders of the affected pixel block and the object edge and pixels located next to a block border in adjacent blocks.

51. A coding device adapted for executing the steps of the method of claim 38, comprising: a grid determining module for determining a grid of pixel blocks on a picture; an edge searching module (2) for determining the presence of an object edge on the picture; a block identifying module (3) for determining at least one affected pixel block containing a pixel of the object edge; and a block identifying module (4) for determining at least one not-affected pixel block neighboring the affected pixel block, the not-affected pixel block not containing a pixel of an object edge; a evaluation module (5) for evaluating a first spatial activity (Act af) of the affected pixel block; and an evaluation module (6) for evaluating a second spatial activity (Act nor) of the not-affected pixel block; a comparison module (7) for comparison of the first spatial activity (Act af) and the second spatial activity (Act nor).

52. The coding device of claim 51 further comprising: a control module (8) for applying a filter (9A, 9B) to the affected pixel block in dependence of the output of the comparison module; the filter (9A, 9B).

53. A decoder device comprising the coding device (FIG. 2) of claim 50 or 51.

54. A display device comprising the coding device (FIG. 2) of claim 51 or 52, and/or the decoder device of claim 53.

55. A data signal of data processed by the method of claim 38, which data represent at least one picture potentially affected by artifacts due to imperfect transform coding said picture having a grid of pixel blocks; an object edge being present (2) on the picture; and at least one affected pixel block containing a pixel (D) of the object edge; and at least one not-affected pixel block neighboring the affected pixel block not containing a pixel of an object edge; wherein the data signal is assigned to an affected pixel block wherein the affected pixel block has a first spatial activity (Act af) and the not-affected pixel block has a second spatial activity (Act_nor).

56. A data signal of claim 55 characterized by being filtered in dependence of the outcome of a comparison of a first spatial activity (Act af) evaluated for the affected pixel block and a second spatial activity (Act nor) evaluated for the not-affected pixel block.

57. A data signal of claim 55 or 56 characterized by being low-pass filtered using a filter-threshold.

58. A data signal of any of the claims 55 to 57 characterized in that a filter-threshold is dependent on the magnitude of the object edge and the first spatial activity (Act af) and the second spatial activity (Act_nor).

59. A computer program product storable on a storage medium and readable by a computing device for processing data which represent at least one picture potentially affected by artifacts due to imperfect transform coding, the program comprising a software code section which induces the computing device to execute the method of claim 38 when the product is executed on the computing device.
